(19) United States
(12) Patent Application Publication
(10) Pub. No.: US 2026/0073219 A1
(43) Pub. Date: Mar. 12, 2026

(54) ELECTRONIC DEVICE AND METHOD FOR PRUNING A NEURAL NETWORK

(71) Applicants: HYUNDAI MOTOR COMPANY, Seoul (KR); KIA CORPORATION, Seoul (KR)

(72) Inventors: Won Seok Jeon, Hwaseong-si (KR); Ju Young Yang, Hwaseong-si (KR); Byeong Wook Jeon, Hwaseong-si (KR)

(73) Assignees: HYUNDAI MOTOR COMPANY, Seoul (KR); KIA CORPORATION, Seoul (KR)

(21) Appl. No.: 19/214,684

(22) Filed: May 21, 2025

(30) Foreign Application Priority Data
Sep. 11, 2024 (KR) 10-2024-0124126

(51) Int. Cl. G06N 3/082; G06N 3/084

(52) U.S. Cl. CPC G06N 3/082; G06N 3/084

(57) ABSTRACT

An electronic device includes a memory storing computer-executable instructions and at least one processor coupled to the memory and configured to execute the computer-readable instructions. The at least one processor is configured to identify a merge layer included in a pruning target model of a neural network to determine a target group including layers, including the merge layer and a sub-layer logically connected with the merge layer. The at least one processor is configured to apply a learnable parameter to each of the layers included in the target group. The at least one processor is configured updates the learnable parameter through propagation of the pruning target model. The at least one processor is configured to perform pruning of the pruning target model based on the updated learnable parameter.

### CROSS-REFERENCE TO RELATED APPLICATION

This application claims the benefit of and priority to Korean Patent Application No. 10-2024-0124126, filed in the Korean Intellectual Property Office on Sep. 11, 2024, the entire contents of which are hereby incorporated herein by reference.

### TECHNICAL FIELD

The present disclosure relates to an electronic device and a method for pruning of a neural network, and more particularly, relates to technologies for weight lightening of the neural network.

### BACKGROUND

Deep learning architectures, particularly, convolutional deep neural networks may be used in artificial intelligence (AI) and computer vision technologies. Such architectures may generate results of tasks including object recognition, detection, and segmentation. If parameters of the neural network are reduced, loads on neural network hardware may be reduced, whereas the level of performance for an image recognition task may be maintained. Particularly, to reduce a parameter size of the neural network, neural networks may be pruned to make a plurality of parameters “0”. However, there may occur a problem in equally regarding importance of each of all layers in a group and omitting more important weights upon pruning, such that a layer of each of the neural networks prunes networks as many as possible.

Particularly, if group-based pruning is adopted for weight lightening of a complex network, there may be a difference in importance of each layer between groups and in the group, but there is no direct adjustment for it. As a result, if pruning without regard to importance proceeds in the group, a network may deteriorate in performance.

### SUMMARY

There is a need to develop a technology for individually applying importance of each of all layers in the group to proceed with pruning, in group-based pruning. The present disclosure has been made to fill this need and to solve the above-mentioned problems occurring in the prior art while advantages achieved by the prior art are maintained intact.

An aspect of the present disclosure provides an electronic device for performing pruning of a pruning target model, based on a learnable parameter, to individually apply importance of each of all layers included in a group to proceed with the pruning, in group-based pruning, and a method for pruning of a neural network.

Another aspect of the present disclosure provides an electronic device for controlling a mobility system based on a pruning target model, pruning of which is performed, to apply a more optimized AI model to an environment with a limited computational resource and a method for pruning of a neural network.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, an electronic device is provided. The electronic device includes a memory storing computer-readable instructions and at least one processor coupled to the memory and configured to execute the computer-readable instructions. The at least one processor is configured to identify a merge layer included in a pruning target model of a neural network to determine a target group including layers, including the merge layer and a sub-layer logically connected with the merge layer. The at least one processor is configured to apply a learnable parameter (which is the basis of pruning of the pruning target model) to each of the layers included in the target group. The at least one processor is configured to update the learnable parameter through propagation of the pruning target model. The at least one processor is further configured to perform pruning of the pruning target model, to generate a pruned target model, based on the updated learnable parameter.

In an embodiment, the at least one processor may be configured to identify the merge layer based on a computational graph of the pruning target model.

In an embodiment, the at least one processor may be configured to apply the learnable parameter to the merge layer to obtain a pruning merge layer. The at least one processor may also be configured to apply the learnable parameter to the sub-layer to obtain a pruning sub-layer.

In an embodiment, the at least one processor may be configured to replace the merge layer of the pruning target model with the pruning merge layer. The at least one processor may also be configured to replace the sub-layer of the pruning target model with the pruning sub-layer.

In an embodiment, the at least one processor may be configured to forward propagate and back propagate the pruning target model including the pruning merge layer and the pruning sub-layer to obtain a loss and may update the learnable parameter based on the loss to which a predetermined regularization term is applied.

In an embodiment, the at least one processor may be configured to determine a skip layer to be excluded from the pruning target model among the layers included in the target group, based on the updated learnable parameter. The at least one processor may be configured to change values included in the skip layer in the pruning target model to a predetermined value to perform the pruning of the pruning target model.

In an embodiment, the at least one processor may be configured to update the layers included in the target group, through propagation of the pruning target model.

In an embodiment, the at least one processor may be configured to determine whether the pruning target model in which the layers included in the target group are updated satisfies a predetermined converge criterion. The at least one processor may be configured to perform the pruning of the pruning target model from applying the learnable parameter to each of the layers included in the target group, based on determining that the pruning target model does not satisfy the predetermined converge criterion.

In an embodiment, the at least one processor may be configured to apply mobility data to the pruned target model to obtain an output and may apply the output to a mobility system to control the mobility system.

According to another aspect of the present disclosure, a method is provided. The method includes identifying a merge layer included in a pruning target model of a neural network to determine a target group including layers, including the merge layer and a sub-layer logically connected with the merge layer. The method also includes applying a learnable parameter (which is the basis of pruning of the pruning target model) to each of the layers included in the target group. The method additionally includes updating the learnable parameter through propagation of the pruning target model. The method further includes performing pruning of the pruning target model, to generate a pruned target model, based on the updated learnable parameter.

In an embodiment, determining the target group may include identifying the merge layer based on a computational graph of the pruning target model.

In an embodiment, performing pruning of the pruning target model may include applying the learnable parameter to the merge layer to obtain a pruning merge layer and applying the learnable parameter to the sub-layer to obtain a pruning sub-layer.

In an embodiment, performing pruning of the pruning target model may include replacing the merge layer of the pruning target model with the pruning merge layer and replacing the sub-layer of the pruning target model with the pruning sub-layer.

In an embodiment, performing pruning of the pruning target model may include forward propagating and back propagating the pruning target model including the pruning merge layer and the pruning sub-layer to obtain a loss and updating the learnable parameter, based on the loss to which a predetermined regularization term is applied.

In an embodiment, performing pruning of the pruning target model may include determining a skip layer capable of being excluded from the pruning target model among the layers included in the target group, based on the updated learnable parameter, and changing values included in the skip layer in the pruning target model to a predetermined value to perform the pruning of the pruning target model.

In an embodiment, the method may further include updating the layers included in the target group through propagation of the pruning target model.

In an embodiment, updating the layers included in the target group may include determining whether the pruning target model in which the layers included in the target group are updated satisfies a predetermined converge criterion and performing the pruning of the pruning target model from applying the learnable parameter to each of the layers included in the target group, based on determining that the pruning target model does not satisfy the predetermined converge criterion.

In an embodiment, the method may further include applying mobility data to the pruned target model to obtain an output and applying the output to a mobility system to control the mobility system.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a drawing illustrating a block diagram of an electronic device according to an embodiment of the present disclosure;

FIG. 2 is a flowchart for describing a method for performing pruning of a neural network in a processor according to an embodiment of the present disclosure;

FIG. 3 is a drawing illustrating an example of not performing group-based pruning;

FIG. 4 is a drawing illustrating an example of performing group-based pruning;

FIG. 5 is a drawing illustrating a computational graph for describing a method for identifying a merge layer, in an electronic device according to an embodiment of the present disclosure;

FIG. 6 is a drawing illustrating an example of performing group-based pruning depending on importance of each of layers in a group, in an electronic device according to an embodiment of the present disclosure;

FIG. 7 is a flowchart for describing a method for performing pruning and training of a neural network, in an electronic device according to an embodiment of the present disclosure;

FIG. 8 is a drawing illustrating an example of a pseudo code of instructions executed by a processor, in an electronic device according to an embodiment of the present disclosure; and

FIG. 9 is a drawing illustrating a computing system associated with an electronic device or a method for performing pruning of a neural network according to an embodiment of the present disclosure.

With regard to description of drawings, the same or similar denotations may be used for the same or similar components.

### DETAILED DESCRIPTION

Hereinafter, embodiments of the present disclosure are described in detail with reference to the accompanying drawings. In adding the reference numerals to the components of the accompanying drawings, it should be noted that the identical components are designated by the identical reference numerals even when the components are displayed on different drawings. In addition, a detailed description of well-known features or functions has been omitted where it was determined that the detailed description would unnecessarily obscure the gist of the present disclosure.

Various embodiments of the present disclosure are described below with reference to the accompanying drawings. However, it should be understood that this is not intended to limit the present disclosure to specific implementation forms. Rather, the present disclosure includes various modifications, equivalents, and/or alternatives of embodiments described herein. With regard to description of drawings, similar components may be marked by similar reference numerals.

In describing components of embodiments of the present disclosure, the terms first, second, A, B, (a), (b), and the like may be used herein. These terms are only used to distinguish one component from another component. These terms do not limit the corresponding components irrespective of the order or priority of the corresponding components. Furthermore, unless otherwise defined, all terms including technical and scientific terms used herein have the same meaning as generally understood by those having ordinary skill in the art to which the present disclosure pertains. Such terms as those defined in a generally used dictionary should be interpreted as having meanings equal to the contextual meanings in the relevant field of art, and should not be interpreted as having ideal or excessively formal meanings unless clearly defined as having such in the present disclosure.

The terms, such as “first”, “second”, “1st”, “2nd”, or the like used in the present disclosure may be used to refer to various components regardless of the order and/or the priority and to distinguish one component from another component. However, these terms do not limit the components. For example, a first user device and a second user device indicate different user devices, irrespective of the order and/or priority of the user devices. For example, without departing from the scope of the present disclosure, a first component may be referred to as a second component, and similarly, a second component may be referred to as a first component.

In the present disclosure, the expressions “have”, “may have”, “include” and “comprise”, “may include”, “may comprise”, or the like indicate existence of corresponding features (e.g., components such as numeric values, functions, operations, or parts), but do not exclude presence of additional features.

It should be understood that when a component (e.g., a first component) is referred to as being “(operatively or communicatively) coupled with/to” or “connected with/to” another component (e.g., a second component), the first component may be directly coupled with/to the second component or an intervening component (e.g., a third component) may be present between the first component and the second component. In contrast, when a component (e.g., a first component) is referred to as being “directly coupled with/to” or “directly connected with/to” another component (e.g., a second component), it should be understood that there is no intervening component (e.g., a third component) between the first component and the second component.

According to the situation, the expression “configured to” used in the present disclosure may be used interchangeably with, for example, the expression “suitable for”, “having the capacity to”, “designed to”, “adapted to”, “made to”, or “capable of”.

The term “configured to” does not necessarily mean “specifically designed to” in hardware. Rather, the expression “a device configured to” may mean that the device is “capable of” operating together with another device or other parts. For example, a “processor configured to perform A, B, and C” may mean a generic-purpose processor (e.g., a central processing unit (CPU) or an application processor) that may perform corresponding operations by executing one or more software programs which store a dedicated processor (e.g., an embedded processor) for performing a corresponding operation or a memory device.

Terms used in the present disclosure are used to describe specified embodiments and are not intended to limit the scope of another embodiment. The terms of a singular form may include plural forms unless the context clearly indicates otherwise. All the terms used herein, including technical or scientific terms, may have the same meaning that is generally understood by a person having ordinary skill in the art described in the present disclosure. It should be further understood that terms that are defined in a dictionary and commonly used should also be interpreted as is customary in the relevant related art and not in an idealized or overly formal manner unless expressly so defined herein in various embodiments of the present disclosure. In some cases, even though terms are terms that are defined in the specification, the terms should not be interpreted to exclude embodiments of the present disclosure.

In the present disclosure, the expressions “A or B”, “at least one of A or/and B”, or “one or more of A or/and B”, or the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. For example, the phrase such as “at least one of A, B, or C, or any combination thereof” may include “A”, “B”, or “C”, or “AB” or “ABC”, which is a combination thereof.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

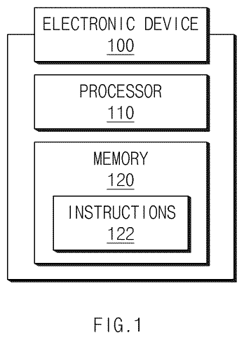

Hereinafter, embodiments of the present disclosure are described in detail with reference to FIGS. 1-9.

FIG. 1 is a drawing illustrating a block diagram of an electronic device according to an embodiment of the present disclosure.

An electronic device 100 according to an embodiment may include a processor 110 and a memory 120 storing computer-readable instructions 122.

The electronic device 100 may be a device that performs weight lightening or reduction of a neural network. For example, the electronic device 100 may identify the neural network. The electronic device 100 may identify layers of the neural network. The electronic device 100 may determine some of the layers of the neural network as a group. The electronic device 100 may learn learnable parameters corresponding to each of the layers included in the group. The electronic device 100 may determine layers that are not important in computation of the neural network among the layers included in the group, based on the learnable parameter. The electronic device 100 may exclude the layers that are not important in the computation of the neural network from the computation of the neural network to perform pruning of the neural network.

The electronic device 100 may define importance of each layer in the group as a learnable weight (e.g.., the learnable parameter). As the training of the neural network progresses, the electronic device 100 may mainly perform pruning of layers with unimportant information in the group. As a result, the electronic device 100 may perform more optimized weight lightening or reduction for a complex network.

The electronic device 100 may control a mobility system, based on the neural network, the weight lightening of which is performed, (e.g., the neural network, the pruning of which is performed). For example, the mobility system may include, but is not limited to, at least one of a vehicle, a robot, an aircraft, or any combination thereof. The electronic device 100 may apply mobility data to the neural network to obtain an output. Illustratively, the electronic device 100 may apply mobility data about a weight of a vehicle to the neural network to obtain an output of a predicted fuel efficiency of the vehicle. The electronic device 100 may apply the output to the mobility system to control the mobility system. The neural network, the weight lightening (i.e., reduction or pruning) of which is performed, may be embedded in the mobility system. In an embodiment, the electronic device 100 may obtain a more optimized output, for example in an environment with a limited computational resource.

The processor 110 may execute software and may control at least one other component (e.g., a hardware or software component) connected with the processor 110. In addition, the processor 110 may perform a variety of data processing or computation functions. For example, the processor 110 may store the neural network in the memory 120. For reference, the processor 110 may perform all operations performed by the electronic device 100. Therefore, for convenience of description in the specification, the operation performed by the electronic device 100 is mainly described as an operation performed by the processor 110.

Furthermore, for convenience of description in the specification, the processor 110 is mainly described as, but not limited to, one processor. For example, the electronic device 100 may include at least one processor. Each of the at least one processor may perform all operations associated with a pruning operation of the neural network.

The memory 120 may temporarily and/or permanently store various pieces of data and/or information required to perform the pruning of the neural network. For example, the memory 120 may store at least one of the neural network, the learnable parameter, the mobility data, or any combination thereof.

The electronic device 100 may further include a communication device. The communication device may assist in performing communication between the electronic device 100 and a server. For example, the communication device may include one or more components for performing communication between the electronic device 100 and the server. As some examples, the communication device may include a short range wireless communication unit, a microphone, or the like. For example, a short range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like.

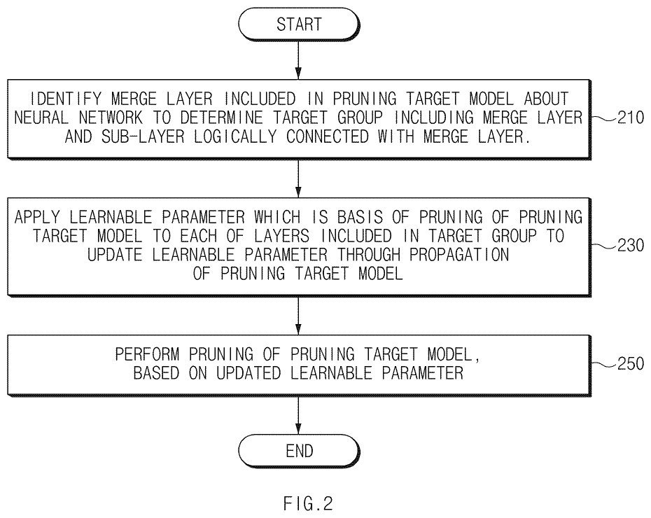

FIG. 2 is a flowchart for describing a method for performing pruning of a neural network in a processor according to an embodiment of the present disclosure.

In an operation 210, a processor (e.g., the processor 110 of FIG. 1) according to an embodiment may identify a merge layer included in a pruning target model of a neural network to determine a target group including the merge layer and a sub-layer logically connected with the merge layer.

For example, the pruning target model may be a model of the neural network, pruning of which is performed. The pruning target model may include the neural network. The neural network may include a plurality of layers. Each layer may include a plurality of nodes. A node may have a node value determined based on an activation function. A node of any layer may be connected with a node (e.g., another node) of another layer through a link (e.g., a connection edge) with a connection weight. The node value of the node may be propagated to other nodes through the link. In an inference operation of the neural network, node values may be forward propagated in the direction of a next layer from a previous layer.

In an example, the forward propagation computation in the pruning target model may be computation of propagating a node value based on input data, in the direction facing the output layer from the input layer of the pruning target model. In other words, a node value of the node may be propagated (e.g., forward propagated) to a node (e.g., a next node) of a next layer connected with the node through the connection edge. For example, the node may receive a value weighted by the connection weight from a previous node (e.g., a plurality of nodes) connected through the connection edge.

In an example, the node value of the node may be determined based on applying the activation function to the sum (e.g., weighted sum) of weighted values received from previous nodes. The parameter of the neural network may illustratively include the above-mentioned connection weight. The parameter of the neural network may be updated to change in a direction in which an objective function value, described in more detail below, is targeted (e.g., a direction in which a loss is minimized).

For example, the trained pruning target model may be a model trained through machine learning and may be a trained machine learning model that outputs a training output based on a training input. The machine learning model (e.g., the trained pruning target model) may be generated based on machine learning. A learning algorithm may include, for example, but is not limited to, supervised learning, unsupervised learning, semi-supervised learning, or reinforcement learning.

In various embodiments, the trained pruning target model may be, but is not limited to, a combination of at least one of a deep neural network (DNN), a convolutional neural network (CNN), a U-net for image segmentation (U-net), a recurrent neural network (RNN), a restricted Boltzmann machine (RBM), a deep belief network (DBN), a bidirectional recurrent deep neural network (BRDNN), deep Q-networks, or any combination thereof.

For supervised learning, the machine learning model may be trained based on training data including a pair of a training input and a training output mapped to the training input. For example, the machine learning model may be trained to output a training output based on a training input. The machine learning model while being trained may generate a temporary output in response to the training input and may be trained such that a loss between the temporary output and the training output (e.g., a training target) is minimized. A parameter of the machine learning model during a learning process (e.g., a connection weight between nodes/layers in the neural network) may be updated according to the loss. In an example, such learning may be performed in the electronic device (e.g., the electronic device 100 of FIG. 1) itself in which the machine learning model is performed and may be performed based on a separate server. The machine learning model, the training of which is performed (e.g., is completed), (e.g., the trained pruning target model) may be stored in a memory (e.g., a memory 120 of FIG. 1).

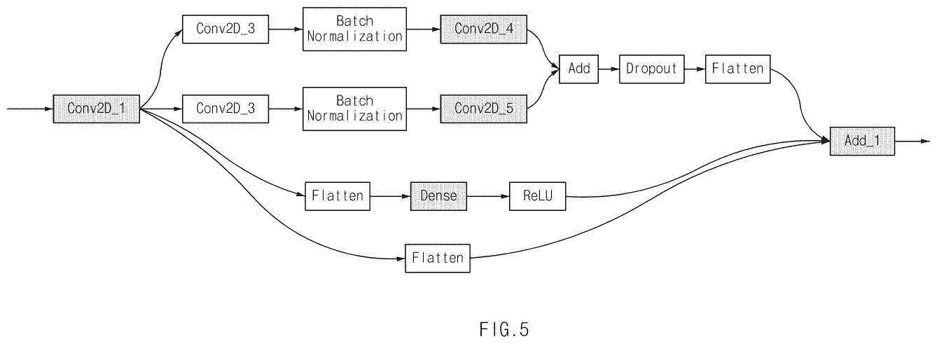

A merge layer may be a layer in which sub-layers are merged with each other. For example, if the pruning target model is a model of the CNN, the merge layer may include a layer of at least one of Add, Multiplication, Concatenate, or any combination thereof. The sub-layer may indicate a layer logically connected with the merge layer. A target group may be a group including the merge layer and the sub-layer. A detailed description of a method for identifying the merge layer and the sub-layer, according to an embodiment, is provided below with reference to FIG. 5.

In an operation 230, the processor may apply a learnable parameter, which is the basis of pruning of a pruning target model, to each of the layers included in the target group to update the learnable parameter, through propagation of the pruning target model. The learnable parameter may include at least one weight. The weight may be applied to one layer among the layers included in the target group. For example, the processor may perform a multiply operation of each of the layers included in the target group and each of weights included in the learnable parameter.

In an example, the propagation of the pruning target model may include forward propagation and back or backward propagation. The processor may update the learnable parameter, through propagation of the pruning target model in which the learnable parameter is applied to each of the merge layer and the sub-layer.

In an operation 250, the processor may perform pruning of the pruning target model, based on the updated learnable parameter. For example, the processor may determine a layer that is a target of the pruning among the layers included in the target group. The processor may change values included in the layer that is the target of the pruning (e.g., a weight for connecting a node and a node, which may be presented as a matrix) to a predetermined value (e.g., 0).

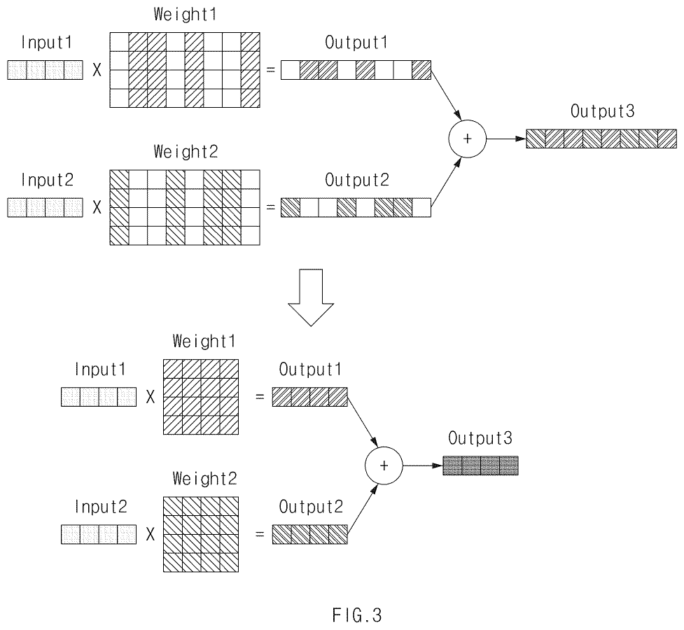

FIG. 3 is a drawing illustrating an example of not performing group-based pruning.

In particular, FIG. 3 illustrates an example of computation of a neural network in which group-based pruning is not performed.

A processor (e.g., the processor 110 of FIG. 1) according to an embodiment may obtain a first output (e.g., Output 1 of FIG. 3), based on computation of a first input (e.g., Input 1 of FIG. 3) and a first weight (e.g., Weight 1 of FIG. 3).

The processor may obtain a second output (e.g., Output 2 of FIG. 3), based on computation of a second input (e.g., Output 2 of FIG. 3) and a second weight (e.g., Weight 2 of FIG. 3).

For example, the first input and the second input may be values of a node of a neural network. The first weight and the second weight may be connection weights between a node of the neural network and a node of the neural network.

In an example, a pruning operation may indicate an operation of changing a value included in the connection weight to a predetermined value, in a layer including a first node (e.g., an input node), the connection weight (e.g., a weight), and a second node (e.g., an output node).

For example, as shown in FIG. 3, the processor may perform pruning of each of the first weight and the second weight. In an embodiment, the processor may change a value included in a first area included in the first weight (e.g., a first column, a fourth column, a sixth column, and a seventh column in the first weight) to a predetermined value. The processor may change a value included in a second area included in the second weight (e.g., a second column, a third column, a fifth column, and an eighth column in the second weight) to the predetermined value.

In an example, the processor may obtain the first output, based on computation of the first input and the first weight, the pruning of which is performed in the first area.

In an example, the processor may obtain the second output, based on computation of the second input and the second weight, the pruning of which is performed in the second area.

In an example, the processor may add the first output and the second output to obtain a third output (e.g., Output 3 of FIG. 3).

In an embodiment, because channels of the first output and the second output are different from each other, the third output may have a channel that is more increased than the channels of the first output and the second output. Accordingly, computation in which two feature maps (e.g., the first output and the second output) are added, for example, summation operation, may fail to obtain a weight-lightened output if the pruned channels are not the same as each other. In other words, because the pruning of the first weight is performed in the first area and the pruning of the second weight is performed in the second area, if outputs with different channels are added, the output of summation operation may fail to have a weight-lightened and/or reduced channel.

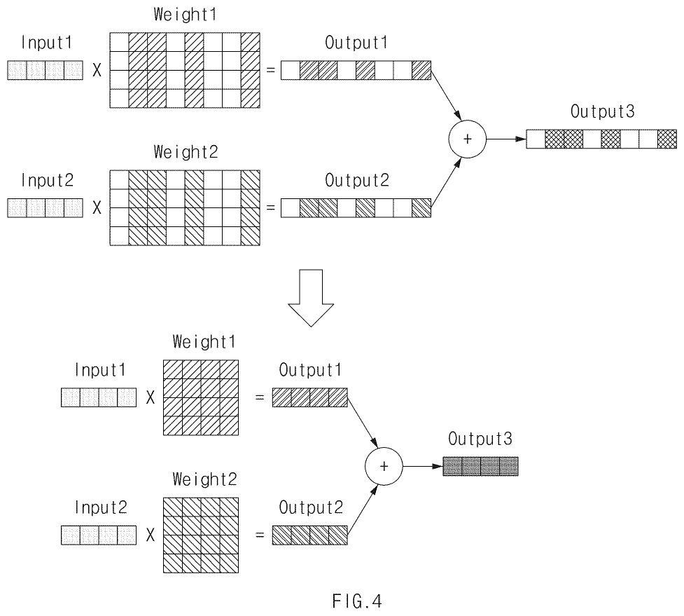

FIG. 4 is a drawing illustrating an example of performing group-based pruning according to an embodiment.

Referring to FIG. 4, FIG. 4 illustrates an example of computation of a neural network, if group-based pruning is performed, according to an embodiment.

A processor (e.g., the processor 110 of FIG. 1) according to an embodiment may obtain a first output (e.g., Output 1 of FIG. 4), based on computation of a first input (e.g., Input 1 of FIG. 4) and a first weight (e.g., Weight 1 of FIG. 4).

The processor may obtain a second output (e.g., Output 2 of FIG. 4), based on computation of a second input (e.g., Input 2 of FIG. 4) and a second weight (e.g., Weight 2 of FIG. 4).

In an example, the first input and the second input may be input values of a node of a neural network. The first weight and the second weight may be connection weights between a node of the neural network and another node of the neural network.

In an example, as shown in FIG. 4, the processor may perform pruning of each of the first weight and the second weight. In an embodiment, the processor may change a value included in a target area included in the first weight (e.g., a first column, a fourth column, a sixth column, and a seventh column in the first weight) to a predetermined value. The processor may also change a value included in a target area included in the second weight to the predetermined value.

The processor may obtain the first output, the pruning of which is performed in the first area, based on computation of the first input and the first weight.

The processor may obtain the second output, the pruning of which is performed in the second area, based on computation of the second input and the second weight.

In an example, the processor may add the first output and the second output to obtain a third output (e.g., Output 3 of FIG. 3).

In an embodiment, because channels of the first output and the second output are the same as each other, the third output may have a channel that is the same as the channels of the first output and the second output. Accordingly, computation in which two feature maps (e.g., the first output and the second output) are added, for example, summation operation, may obtain a weight-lightened output if the pruned channels are the same each other. In other words, because the pruning of the first weight and the second weight is performed in the target area, if outputs with the same channel are added, the output of summation operation may have a weight-lightened and/or reduced channel.

Unlike the pruning described in FIG. 3, the pruning described in FIG. 4 may be pruning based on a group. For example, pruning based on the group may prune each of sub-layers logically connected with a merge layer included in the group in the same area and the same channel. As a result, the processor may perform the pruning based on the group to obtain an output, the number of channels of which is reduced. Hereinafter, a detailed description of the operation of performing the pruning based on the weight of each of the layers included in the group, in a group-based pruning according to an embodiment, is provided with reference to FIGS. 5-7.

FIG. 5 is a drawing illustrating a computational graph for describing a method for identifying a merge layer, in an electronic device according to an embodiment of the present disclosure.

A processor (e.g., the processor 110 of FIG. 1) according to an embodiment may identify a merge layer included in a pruning target model. The processor may determine a target group including a merge layer and a sub-layer. The processor may apply a learnable parameter to each of the layers included in the target group and may update the learnable parameter through propagation of the pruning target model. The processor may perform pruning of the pruning target model based on the updated learnable parameter.

For example, the processor may identify at least one merge layer in the pruning target model. Illustratively, the processor may identify a first merge layer and second to nth merge layers. The processor may determine a target group for every identified merge layer. For example, the processor may determine a first target group including the first merge layer, may determine a second target group including the second merge layer, etc., and may determine an nth target group including the nth merge layer.

For example, the processor may apply respective learnable parameters to every target group. As a result, the processor may perform group-based pruning. Furthermore, the processor may differently perform pruning of each of layers included in each group based on the learnable parameter, rather than equally performing pruning of the layers included in each group, to perform the group-based pruning. Hereinafter, in FIGS. 5-8, a description is provided of a detailed method for identifying one merge layer, determining one target group, and applying a learnable parameter to each of layers included in the one target group in the processor, according to embodiments of the present disclosure.

In an example, the processor may identify the merge layer based on a computational graph of the pruning target model. FIG. 5 illustrates a computational graph of a pruning target model, according to an embodiment. The pruning target model with the computational graph shown in FIG. 5 may be a model of a CNN.

For example, the processor may identify a merge layer in which layers are merged and/or connected with each other, on the computational graph. Illustratively, the processor may identify an “Add” layer as the merge layer, on the computational graph. For the merge layer shown in FIG. 5, the merge layer may be connected with a convolution layer, a “Dense” layer, and a “Flatten” layer.

For example, if identifying the merge layer, the processor may identify a sub-layer logically connected with the merge layer. Illustratively, if identifying the “Add” layer as the merge layer, the processor may identify a “Conv2D_1” layer, a “Conv2D_4” layer, a “Conv2D_5”, and a “Dense” layer as sub-layers logically connected with the merge layer.

For example, if identifying the merge layer and the sub-layer, the processor may determine the target group including the merge layer and the sub-layer. In other words, the target group may include the merge layer (e.g., the “Add” layer) and the sub-layers (e.g., the “Conv2D_1” layer, the “Conv2D_4” layer, the “Conv2D_5” layer, and the “Dense” layer).

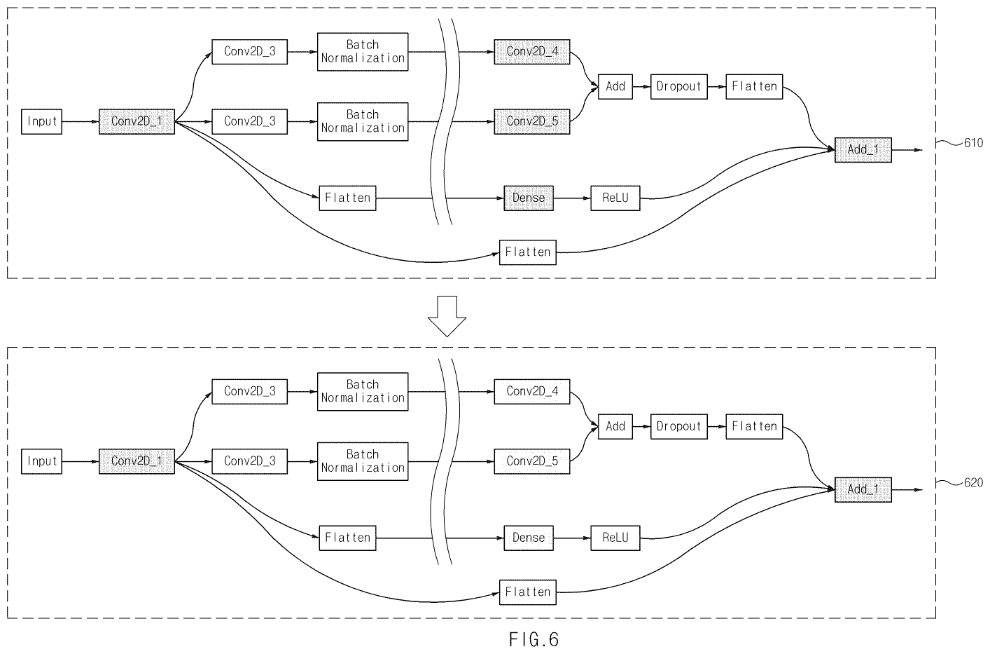

FIG. 6 is a drawing illustrating an example of performing group-based pruning based on importance of each of layer in a group, in an electronic device according to an embodiment of the present disclosure.

A processor (e.g., the processor 110 of FIG. 1) according to embodiment may identify a merge layer included in a pruning target model to determine a target group including the merge layer and a sub-layer logically connected with the merge layer. In an embodiment, the target group described in FIG. 6 may be the target group described in FIG. 5.

The pruning target model may be in a first state 610 and a second state 620.

In an example, the first state 610 may be a state before pruning of the pruning target model. The second state 620 may be a state after the pruning of the pruning target model.

The processor may perform pruning of the pruning target model in the first state 610 to obtain the pruning target model in the second state 620. For example, the processor may perform pruning of the pruning target model based on an updated learnable parameter. The processor may perform pruning of the pruning target model to obtain the pruning target model in the second state 620.

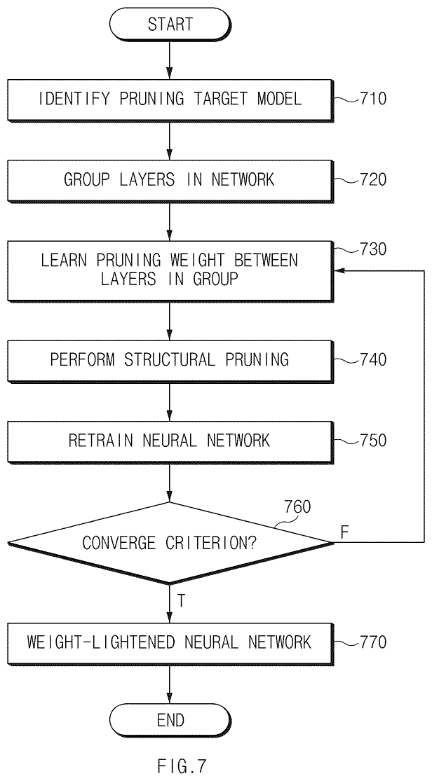

FIG. 7 is a flowchart for describing a method for performing pruning and training of a neural network, in an electronic device according to an embodiment of the present disclosure.

In an operation 710, a processor (e.g., the processor 110 of FIG. 1) according to embodiment may identify a pruning target model. For example, the processor may obtain the pruning target model from a server through a communication device. The processor may store the obtained pruning target model in a memory (e.g., the memory 120 of FIG. 1).

In an operation 720, the processor may group layers in a network (e.g., a pruning target model). For example, the processor may identify the pruning target model to determine a target group including a merge layer and a sub-layer logically connected with the merge layer. The processor may determine target groups, each of which includes each of merge layers included in the pruning target model and a sub-layer connected with each of the merge layers.

In an operation 730, the processor may learn a pruning weight between the layers in the group. For example, the pruning weight may indicate a learnable parameter.

In an example, the processor may apply the learnable parameter to the merge layer to obtain a pruning merge layer. The processor may apply the learnable parameter to the sub-layer to obtain a pruning sub-layer.

The processor may replace the merge layer of the pruning target model with the pruning merge layer. The processor may place the sub-layer of the pruning target model with the pruning sub-layer.

The processor may forward propagate and back propagate the pruning target model including the pruning merge layer and the pruning sub-layer (i.e., learn the pruning weight) to obtain a loss.

The processor may update the learnable parameter, based on applying a predetermined regularization term to the loss. Herein, the loss may be a loss for training the pruning target model.

In an operation 740, the processor may perform structural pruning.

For example, the processor may determine a skip layer capable of being excluded from the pruning target model among the layers included in the target group, based on the updated learnable parameter. In an embodiment, the skip layer may include all the layers included in the target group or may include some of the layers included in the target group.

The processor may change values included in the skip layer in the pruning target model to a predetermined value to perform pruning of the pruning target model. For example, the processor may change the values included in the skip layer to predetermined “0” to deactivate intervention of the skip layer in a computation process of the pruning target model.

In an operation 750, the processor may retrain a neural network (i.e., the pruning target model).

For example, the processor may update the layers included in the target group, through propagation of the pruning target model, the pruning of which is performed. In detail, the processor may update the remaining layers, other than the skip layer, among the layers included in the target group. In an embodiment, the processor may use the loss described above in operation 730 to train the pruning target model.

In an operation 760, the processor may determine a converge criterion of the pruning target model.

For example, the processor may determine whether the pruning target model in which the layers included in the target group are updated satisfies a predetermined converge criterion. In an embodiment, the predetermined converge criterion may include whether it changes in a direction in which an objective function value or a loss is targeted (e.g., a direction in which the loss is minimized).

The processor may perform an operation (e.g., operation 740) of performing the pruning of the pruning target model from an operation (e.g., operation 730) of applying the learnable parameter to each of the layers included in the target group based on determining that the pruning target model does not satisfy the converge criterion (F at operation 760).

In an operation 770, the processor may obtain the weight-lightened neural network (i.e., the pruning target model, the pruning of which is performed, also referred to herein a “pruned target model”) based on determining that the pruning target model does satisfy the converge criterion (T at operation 760). The processor may end the pruning and retraining of the pruning target model based on determining that the pruning target model satisfies the converge criterion (T at operation 760).

The processor may apply mobility data to the pruned target model to obtain an output. The processor may apply the output to a mobility system to control the mobility system.

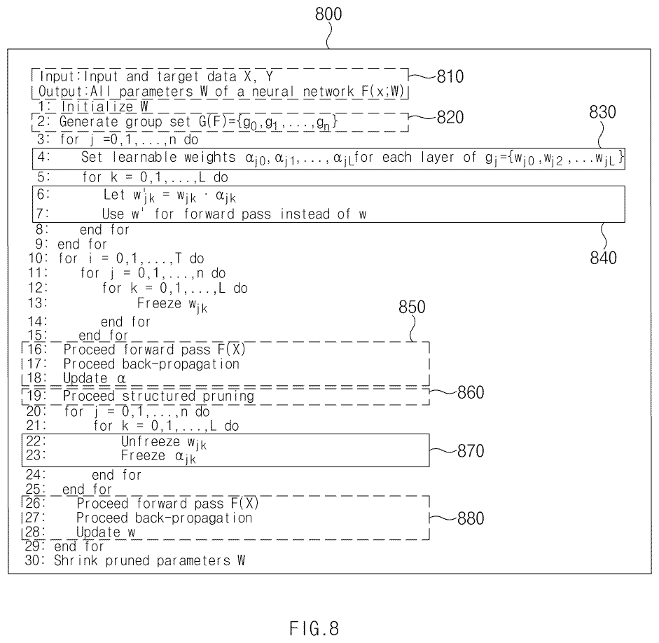

FIG. 8 is a drawing illustrating an example of a pseudo code of instructions executed by a processor, in an electronic device according to an embodiment of the present disclosure.

A processor (e.g., the processor 110 of FIG. 1) according to an embodiment may execute instructions included in a pseudo code 800. The processor may execute the instructions included in the pseudo code 800 to perform pruning and retraining of a pruning target model.

For example, a first code 810 may include an input and an output of the pseudo code 800. Illustratively, the input may include a training input and a training output to be used to train the pruning target model. The output may include all parameters of the pruning target model (i.e., a connection weight of the pruning target model).

For example, a second code 820 may include a command to determine a target group. For example, if there are n merge layers in the pruning target model, the processor may perform the second code 820 to determine and/or obtain n target groups.

For example, a third code 830 may include a command to set a learnable parameter in the target group.

For example, a fourth code 840 may include a command to apply the learnable parameter to the target group. If there are the n target groups, the number of learnable parameters may be n. One learnable parameter may include a plurality of values, depending on layers included in one target group. Illustratively, if the target group is gⱼ, the processor may apply a learnable parameter including αⱼ₀, αⱼ₁, . . . , α_{jL} to each of layers (e.g., wⱼ₀, wⱼ₁, . . . , w_{jL}) included in the target group. The processor may replace the layer of the pruning target model with layers to which the learnable parameter is applied.

For example, a fifth code 850 may include a command to update the learnable parameter, through propagation of the pruning target model.

For example, a sixth code 860 may include a command to perform pruning of the pruning target model, based on the updated learnable parameter.

For example, a seventh code 870 may indicate a command to perform pre-processing to train the pruning target model, the pruning of which is performed. In detail, the processor may replace the layers to which the learnable parameter is applied in the pruning target model with layers before the learnable parameter is applied.

For example, an eighth code 880 may include a command to update the layers included in the target group and/or all layers included in the pruning target model, through propagation of the pruning target model, the pruning of which is performed.

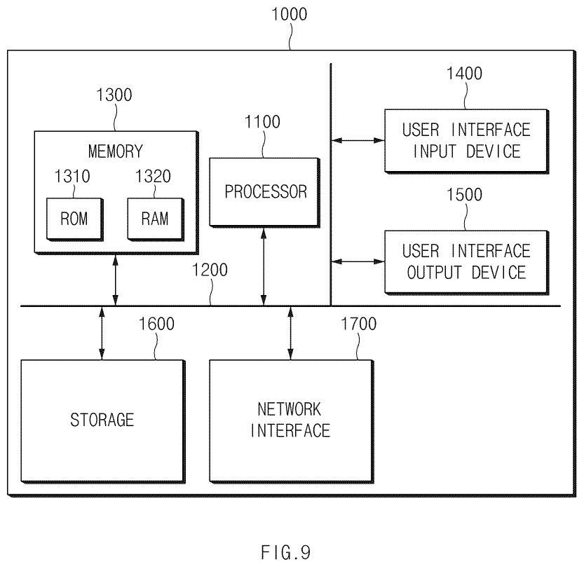

FIG. 9 is a drawing illustrating a computing system that may be used with an electronic device or a method for performing pruning of a neural network according to an embodiment of the present disclosure.

Referring to FIG. 9, a computing system 1000 that may be used with the electronic device or the method for performing the pruning of the neural network may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

Hereinabove, although the present disclosure has been described with reference to certain embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected over networks and be stored or executed in a dispersion manner. Software and data may be recorded in one computer-readable storage media.

The methods according to embodiments of the present disclosure may be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

The above-described hardware devices may be configured to act as one or a plurality of software modules to perform the operations of the embodiments, or vice versa.

Even though the embodiments are described with reference to restricted drawings, it should be apparent to one or ordinary skill in the art that the embodiments are variously changed or modified based on the above description. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

A description of effects of the electronic device and the pruning method of the neural network according to embodiments of the present disclosure is provided herein below.

According to at least one of embodiments of the present disclosure, the electronic device may perform pruning of a pruning target model, based on a learnable parameter, thus individually applying importance of each of all layers included in a group to proceed with the pruning, in group-based pruning.

Furthermore, according to at least one embodiment of the present disclosure, the electronic device may control a mobility system based on the pruning target model, the pruning of which is performed, thus applying a more optimized AI model to an environment with a limited computational resource.

In addition, various effects ascertained directly or indirectly through the present disclosure may be provided.

Therefore, other implements, other embodiments, and equivalents are within the scope of the following claims.

Therefore, embodiments of the present disclosure are not intended to limit the technical spirit of the present disclosure, but provided only for illustrative purpose. The scope of the present disclosure should be construed on the basis of the accompanying claims, and all the technical ideas within the scope equivalent to the claims should be included in the scope of the present disclosure.

What is claimed is:

1. An electronic device, comprising:
a memory storing computer-readable instructions; and
at least one processor coupled to the memory, the at least one processor configured to execute the computer-readable instructions to:
identify a merge layer included in a pruning target model of a neural network to determine layers, including a target group including the merge layer and a sub-layer logically connected with the merge layer;
apply a learnable parameter to each of the layers included in the target group;
update the learnable parameter through propagation of the pruning target model; and
perform pruning of the pruning target model, to generate a pruned target model, based on the updated learnable parameter.

2. The electronic device of claim 1, wherein the at least one processor is configured to identify the merge layer based on a computational graph of the pruning target model.

3. The electronic device of claim 1, wherein the at least one processor is configured to:
apply the learnable parameter to the merge layer to obtain a pruning merge layer; and
apply the learnable parameter to the sub-layer to obtain a pruning sub-layer.

4. The electronic device of claim 3, wherein the at least one processor is configured to:
replace the merge layer of the pruning target model with the pruning merge layer; and
replace the sub-layer of the pruning target model with the pruning sub-layer.

5. The electronic device of claim 4, wherein the at least one processor is configured to:
forward propagate and back propagate the pruning target model including the pruning merge layer and the pruning sub-layer to obtain a loss; and
update the learnable parameter based on the loss to which a predetermined regularization term is applied.

6. The electronic device of claim 5, wherein the at least one processor is configured to:
determine a skip layer to be excluded from the pruning target model, among the layers included in the target group, based on the updated learnable parameter; and
change values included in the skip layer in the pruning target model to a predetermined value to perform pruning of the pruning target model.

7. The electronic device of claim 1, wherein the at least one processor is configured to update the layers included in the target group through propagation of the pruned target model.

8. The electronic device of claim 7, wherein the at least one processor is configured to:
determine whether the pruning target model in which the layers included in the target group are updated satisfies a predetermined converge criterion; and
perform pruning of the pruning target model by applying the learnable parameter to each of the layers included in the target group, based on determining that the pruning target model does not satisfy the predetermined converge criterion.

9. The electronic device of claim 1, wherein the at least one processor is configured to:
apply mobility data to the pruned target model to obtain an output; and
apply the output to a mobility system to control the mobility system.

10. A method, comprising:
identifying a merge layer included in a pruning target model of a neural network to determine a target group including layers, including the merge layer and a sub-layer logically connected with the merge layer;
applying a learnable parameter to each of the layers included in the target group;
updating the learnable parameter through propagation of the pruning target model; and
performing pruning of the pruning target model, to generate a pruned target model, based on the updated learnable parameter.

11. The method of claim 10, wherein determining the target group includes identifying the merge layer based on a computational graph of the pruning target model.

12. The method of claim 10, wherein performing pruning of the pruning target model includes:
applying the learnable parameter to the merge layer to obtain a pruning merge layer; and
applying the learnable parameter to the sub-layer to obtain a pruning sub-layer.

13. The method of claim 12, wherein performing pruning of the pruning target model includes:
replacing the merge layer of the pruning target model with the pruning merge layer; and
replacing the sub-layer of the pruning target model with the pruning sub-layer.

14. The method of claim 13, wherein performing pruning of the pruning target model includes:
forward propagating and back propagating the pruning target model including the pruning merge layer and the pruning sub-layer to obtain a loss; and
updating the learnable parameter based on the loss to which a predetermined regularization term is applied.

15. The method of claim 14, wherein performing pruning of the pruning target model includes:
determining a skip layer to be excluded from the pruning target model among the layers included in the target group, based on the updated learnable parameter; and
changing values included in the skip layer in the pruning target model to a predetermined value to perform the pruning of the pruning target model.

16. The method of claim 10, further comprising updating the layers included in the target group through propagation of the pruned target model.

17. The method of claim 16, wherein updating the layers included in the target group includes:
determining whether the pruning target model in which the layers included in the target group are updated satisfies a predetermined converge criterion; and
performing pruning of the pruning target model by applying the learnable parameter to each of the layers included in the target group, based on determining that the pruning target model does not satisfy the predetermined converge criterion.

18. The method of claim 10, further comprising:
applying mobility data to the pruned target model to obtain an output; and
applying the output to a mobility system to control the mobility system.
